(19) United States
(12) Patent Application Publication
(10) Pub. No.: US 2024/0322338 A1
(43) Pub. Date: Sep. 26, 2024

(54) ENERGY STORAGE DEVICE

(71) Applicant: AUDI AG, Ingolstadt (DE)

(72) Inventor: Thorsten BUßMANN, Heilbronn (DE)

(73) Assignee: AUDI AG, Ingolstadt (DE)

(21) Appl. No.: 18/582,966

(22) Filed: Feb. 21, 2024

(30) Foreign Application Priority Data
Mar. 20, 2023 (DE) 102023106883.0

(51) Int. Cl. H01M 50/249; H01M 50/242; H01M 50/244; H01M 50/262

(52) U.S. Cl. CPC H01M 50/249; H01M 50/242; H01M 50/244; H01M 50/262; H01M 2220/20

(57) ABSTRACT

An energy storage device with a housing and with at least one storage module accommodated therein, and a frame to which the housing is fastened by screw elements screwed at distinct fastening positions. The frame has at least two longitudinal beams, which are formed by metal hollow profile elements. Each hollow profile element has a main portion and at least one chamber portion which projects laterally therefrom towards the housing, into which the screw elements are screwed in. The chamber portion is provided with one or more weakening devices to facilitate collapse of the chamber portion in the event of a force acting with a horizontal force component.

### FIELD

The invention relates to an energy storage device, comprising an energy storage with a housing and at least one storage module accommodated therein, as well as a frame to which the housing is fastened by means of screw elements screwed at distinct fastening positions, wherein the frame has at least two longitudinal beams which are formed by metal hollow profile elements.

### BACKGROUND

Partially or fully electric vehicles have a correspondingly sized energy storage device that enables electric driving operation. The energy storage device comprises an energy storage that has at least one storage module, usually a plurality of corresponding storage modules, and a housing in which the storage module or modules are accommodated. The housing in turn is attached to a frame of the energy storage device by means of suitable screw elements, wherein the screw elements are screwed to suitable longitudinal beams of the frame at distinct fastening positions. The longitudinal beams are formed by metal hollow profile elements, wherein each longitudinal beam usually is divided into multiple longitudinal hollow chambers. The energy storage device is attached to a body of the vehicle via this frame, for which purpose suitable screw connections are used in turn. Such an energy storage device is known, for example, from US 2018 050607 A1. In this energy storage device, the longitudinal beams are designed to be flat on their inner side facing the module housing(s), while a laterally projecting hollow chamber portion projects on the opposite outer side. The frame is screwed on the body side via this hollow chamber portion. This hollow chamber portion serves to stiffen the longitudinal beam. In the case of a lateral force input, especially if this is local, for example if there is a collision with a post or pile, there is a local deformation of the longitudinal beam, which propagates towards the storage module or modules, which can be affected.

### SUMMARY

The invention is therefore based on the problem of specifying an improved energy storage device.

To solve this problem, in an energy storage device of the type mentioned at the outset, it is provided according to the invention that each hollow profile element has a main portion and at least one chamber portion which projects laterally to the housing and into which the screw elements are screwed, wherein the chamber portion is provided with one or more weakening devices to facilitate a collapse of the chamber portion in the event of a force acting with a horizontal force component.

In the energy storage device according to the invention, an intrinsic weakening structure is provided between the frame or each longitudinal beam and the housing of the energy storage device, which is fixed in the frame. For this purpose, the longitudinal beam has a specific shape or cross-sectional structure. The longitudinal beam has a main portion, which is preferably formed through multiple separate hollow chambers. These hollow chambers are, for example, arranged vertically one above the other. On the inner side of the longitudinal beam, at least one laterally projecting chamber portion is provided, which projects towards the inner side of the frame, i.e. towards the energy storage itself. The housing is screwed to this chamber portion using the screw connections. On the one hand, appropriate stiffening is achieved via this projecting chamber portion, which extends over the length of the longitudinal beam. On the other hand, this results in a spacing of the main portion of the longitudinal beam to the energy storage. In order to prevent the action of a local force from leading to a correspondingly strong deformation that is passed on to the energy storage device, according to the invention the chamber portion is provided with one or more weakening devices which enable the chamber portion to collapse locally when the force is applied and thus to deform locally in a targeted manner, so that the force is reduced. The fact that the main portion of the longitudinal beam is spaced from the adjacent storage housing via the chamber portion also creates a kind of damping space into which the main portion can deform without the housing being impaired or subjected to excessive force, which is thus better protected.

Two projecting chamber portions are preferably provided, which are spaced apart from one another when viewed transversely to the longitudinal direction of the longitudinal beam, and which are provided in particular at the upper and lower ends of the longitudinal beam, wherein both chamber portions are provided with one or more weakening devices. In this case, the longitudinal beam is stiffened via two projecting chamber portions, which, viewed vertically, are spaced apart from one another and are preferably provided at the ends of the main portion. They define a damping space between them, into which the main portion can be deformed if the chamber portions are deformed. In order to enable this deformation in the event of a collision, both chamber portions are provided with corresponding weakening devices, so that a corresponding deformation and thus a corresponding reduction in force can take place on both.

The chamber portion delimited by a chamber wall preferably has a square, in particular a trapezoidal, cross-section, wherein the chamber wall has a lower and an upper wall as well as a front wall connecting the two. On the one hand, a good stiffening of the longitudinal beam is possible via such a cross-sectional profile, but on the other hand, this design also allows the formation of corresponding weakening devices.

According to a first variant of the invention, the or each weakening device can be formed by means of an opening passing through a chamber wall defining the chamber portion. For local weakening, the chamber portion or the chamber wall is locally perforated, wherein of course multiple openings can be formed in the chamber wall as seen over the length of the chamber portion.

The or each opening can only pass through one wall of the chamber wall. This means that only one wall is correspondingly weakened. However, it is also conceivable that multiple walls of the chamber portion are penetrated, so that the weakening extends locally over a larger wall region.

An opening can be in the form of a hole, that is, the chamber wall is drilled through at the desired locations. The formation of such holes allows, in particular, the local weakening of an individual wall. Alternatively, an opening can also be designed in the form of a slot. Such a slot can only be formed locally in a wall, but it can also easily extend over two or over all walls. It is expedient if the or each slot extends vertically to a longitudinal axis of the longitudinal beam. This means that, as seen from the front wall, the vertical slots are cut into the chamber wall and preferably open all three walls.

As an alternative to forming one or more openings, it is also conceivable that the or each weakening device is formed by means of a depression that deforms a chamber wall defining the chamber portion. In this case, a weakening device is formed via a corresponding geometric structure in the form of a local depression or recess, which locally deforms the chamber wall. This can also be used to form a local predetermined deformation point.

Here too, the or each recess can only be provided in one wall or in multiple walls. The depression can also extend over multiple walls. This means that an individual wall can be deformed only locally, i.e. only have a local depression. Alternatively, a depression extending over two or even all walls can also be formed. Such a depression can in particular be designed in the form of an embossed bead.

According to a further variant, the or each weakening device can be formed by means of a material weakening that reduces the thickness of a chamber wall defining the chamber portion. According to this embodiment of the invention, the chamber wall is made locally thinner in order to form the weakening device, i.e. the predetermined deformation point.

This material weakening can be easily achieved by local material removal.

Here too, the or each material weakening can be provided only locally in one wall or in multiple walls. But it can also extend over multiple walls.

The two longitudinal beams extend along the housing as described. Depending on how large the energy storage device is, each side beam can have a length of 1 m or more. Since a local force input can occur at any position of the longitudinal beam in the event of a collision, it is expedient if multiple fastening positions are provided along the longitudinal beam, wherein at least one weakening device is provided between two adjacent fastening positions. This means that a large number of individual weakening devices are formed along the length of the longitudinal beam, each of which enables targeted local deformation in the event of a local force application.

In this case, multiple weakening devices are preferably provided at a constant distance from one another between two fastening positions, at which corresponding screw elements are screwed. If, for example, the screw elements are placed at a distance of 25 cm, then at this distance, for example, 4 weakening devices can be formed at a distance of 5 cm from one another.

In addition to the energy storage device itself, the invention also relates to a motor vehicle, comprising at least one energy storage device of the type described above.

### BRIEF DESCRIPTION OF THE FIGURES

Further advantages and details of the present invention will be apparent from the exemplary embodiments described below and in reference to the drawings. In the following:

FIG. 1 shows a schematic representation of an energy storage device according to the invention in an assembled state in a motor vehicle according to the invention,

FIG. 2 shows a schematic representation of a longitudinal beam in a partial perspective view with weakening devices designed as slots,

FIG. 3 shows a schematic representation of a longitudinal beam in a partial perspective view with weakening devices designed as bores,

FIG. 4 shows a schematic representation of a longitudinal beam in a detailed perspective view with weakening devices designed as embossed notches, and

FIG. 5 shows a schematic representation of a longitudinal beam in a detailed perspective view with weakening devices designed as material weakening.

### DETAILED DESCRIPTION

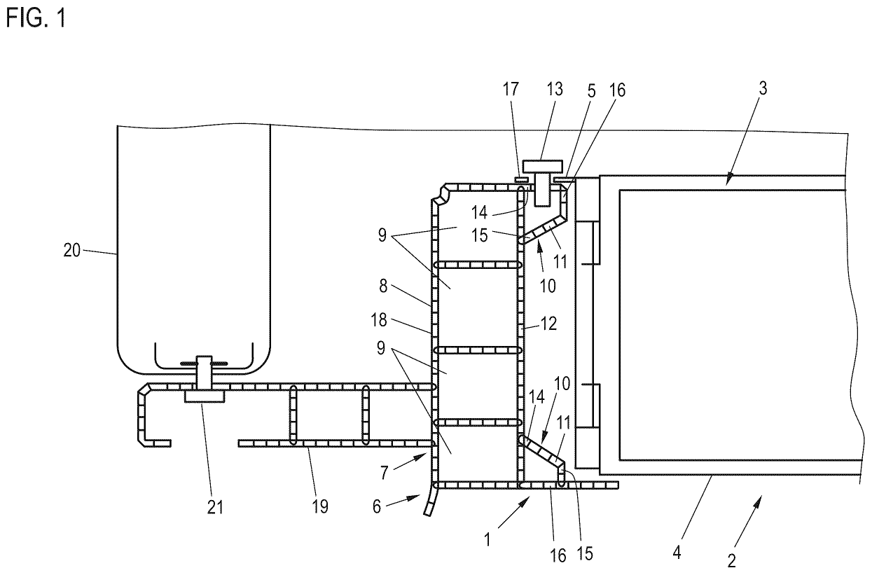

FIG. 1 shows, in the form of a partial view as a schematic representation, an energy storage device 1 according to the invention. This comprises an energy storage device 2 with one, usually multiple storage modules 3, each of which is accommodated in a housing 4 of the energy storage device 2. The housing 4 has multiple fastening tabs 5 distributed over its length, via which the energy storage device 2 is fastened to a frame 6. For this purpose, the frame 6 has two longitudinal beams 7, which are designed as metal hollow profile elements made of aluminum or steel. The longitudinal beams 7 extend on the long sides of the frame 6; they can be connected via corresponding cross beams.

Each longitudinal beam 7 includes a main portion 8, which is divided into multiple individual hollow chambers 9. A hollow chamber portion 10 is provided at the upper and lower edge of the main portion 8 and is delimited by a chamber wall 11. In the example shown, each chamber portion 10 has a trapezoidal cross-section and extends from the inner side 12 of the main portion 8 inwards towards the energy storage 2. The energy storage 2 in turn is fastened to the upper chamber portion 11 by means of a plurality of individual screw elements 13 which are screwed into the chamber wall 11. The chamber wall 11 in turn has an upper wall 14, a lower wall 15 and a front wall 16 connecting the two, wherein the screw elements 13 are screwed into the upper wall 14. The screw elements 13 pass through a corresponding opening 17 in the respective fastening tab 5, so that the energy storage device 2 or the housing 4 is firmly screwed to the frame 6.

The frame 6 in turn has a further frame portion 19 extending from the outer side 18 to the side, via which the energy storage device 1 is screwed to a body beam 20 via suitable screw connections 21.

If, in the event of a collision, a lateral force is applied to the longitudinal beam 7, measures are provided according to the invention that enable the chamber portion 10, to which the energy storage 2 is screwed, to collapse in a targeted manner. For this purpose, at least on the upper chamber portion 10, but preferably also on the lower chamber portion 10, a plurality of individual weakening devices 22 are formed, which are distributed over the length of the respective chamber portion 10 and which locally weaken the chamber portion 10 or the chamber wall 11, so that on the one hand each chamber portion 10 or each chamber wall 11 serves to stiffen the longitudinal beam 7, but at the same time can also specifically collapse locally when a side force acts thereon.

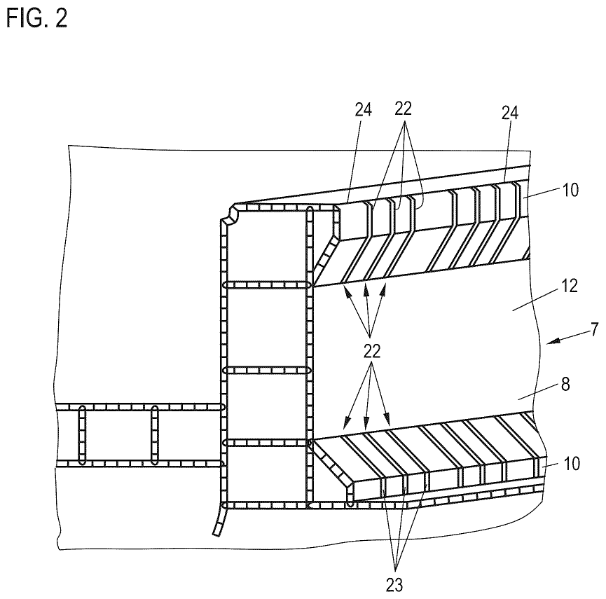

FIG. 2 shows a first embodiment of the invention of a longitudinal beam 7 in a perspective view viewed in the direction of the inner side 12 of the main portion 8 and the two chamber portions 10. As can be seen, each chamber portion 10 is provided with a plurality of individual weakening devices 22, which are designed here in the form of slots 23. In the case of the upper chamber portion 10, the slots 23 extend from the upper wall 14 over the front wall 16 into the lower wall 15. In the case of the lower chamber portion 10, the slots 23 only extend from the upper wall into the front wall 16. Multiple slots 23 are respectively formed between two openings 24, which are formed in the upper wall 14 and into which a screw connection 13 is screwed.

If a lateral force is applied, the upper and possibly also the lower chamber portion 10 can deform in a locally targeted manner and collapse in the area of one or more slots 23, so that force can thus be reduced. This force is therefore not transferred to the energy storage housing 4 and thus to the energy storage 2. In addition, the design of the laterally projecting chamber portions 10 makes it possible for the main portion 8 to be spaced from the energy storage housing 4, so that a sort of damping volume is provided into which the main portion 8 can be deformed in the event of a collision, without the energy storage housing 4 being directly subject to force.

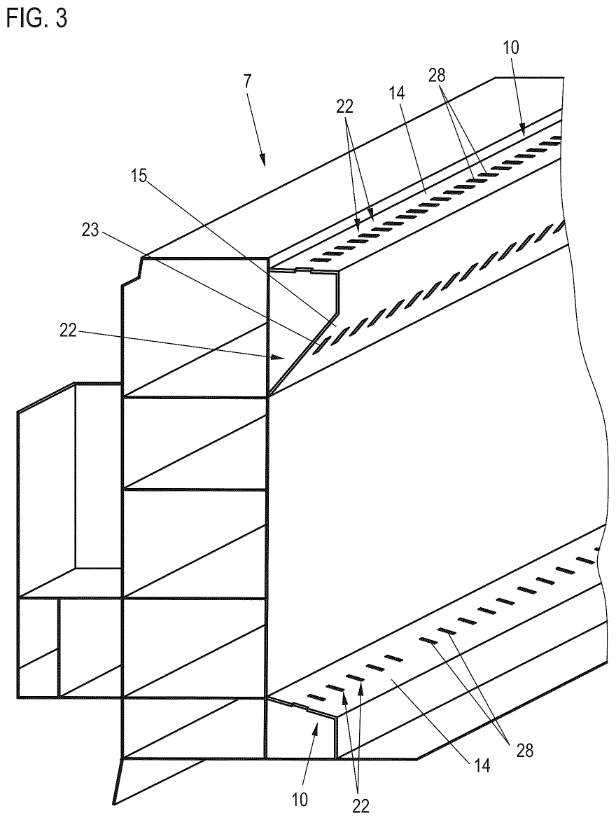

FIG. 3 shows a further embodiment of a longitudinal beam 7, the basic structure of which corresponds to that of FIGS. 1 and 2. Also in this case the two chamber portions 10 in the area of the respective upper wall 14 are provided with corresponding weakening devices 22, but here in the form of bores 28. The lower wall 15 can also be provided with corresponding weakening devices 22 in the form of bores 28, as shown in FIG. 3. These weakening devices 22 also allow local collapse, as already described above for FIG. 2.

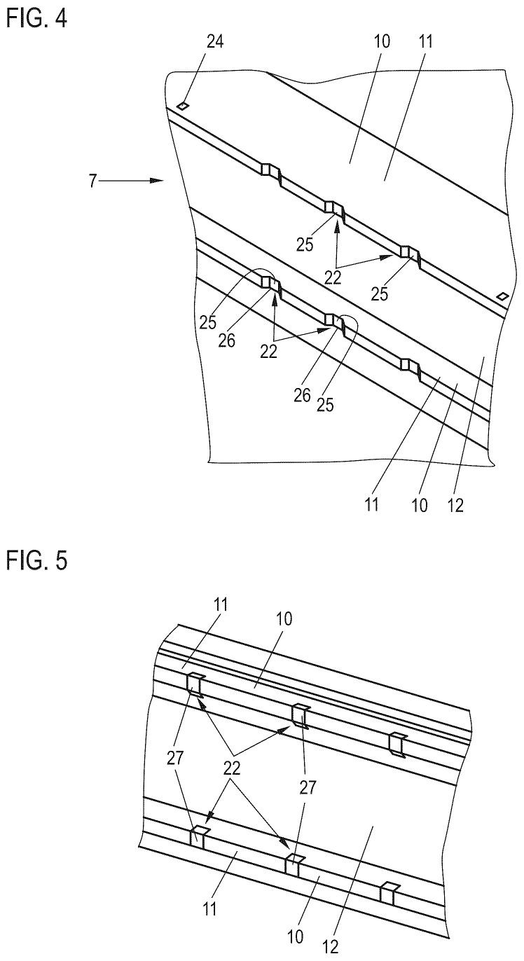

Another inventive variant of a longitudinal beam design is shown in FIG. 4. The inner side 8 of the longitudinal beam 7 is again shown with the two projecting chamber portions 10. Both chamber portions 10 are again provided with corresponding weakening devices 22, which are designed here in the form of a depression 25. Each depression 25 is designed as an embossed bead 26. Here the weakening devices 22 are thus geometric deformations of the chamber wall 11 of each chamber portion 10. As shown in FIG. 4, in this variant too, multiple depressions 25 are provided between two openings 24, which, as described, serve to accommodate the screw elements 13. Corresponding local desired bending points or desired deformation points are also formed via these geometric weakening devices 22 in the form of beads 26, at which the respective chamber portion 10 deforms accordingly when a local force is applied in order to reduce the applied force, so that this force is not passed on to the energy storage device 2 or is only passed on in a reduced manner.

FIG. 5 finally shows a further embodiment of a longitudinal beam 7, again with a view on the inner side 12 of the main portion 8. Here too, the two chamber portions 10 are provided with corresponding weakening devices 22, which are provided here in the form of a material weakening 27. This means that the material of the chamber wall 11 is locally thinner than in neighboring wall portions. This material weakening can be achieved by simply removing material in this region.

A local collapse is also possible in these local regions, which are weakened by a reduction in thickness, when a horizontal force is applied. Here too, the respective material weakening 27 extends over multiple walls 14, 15, 16, as clearly shown in FIG. 5.

Although the figures only show one longitudinal beam 7 of the frame 6, it goes without saying that the other longitudinal beam 7, which is provided on the other side of the frame, is of course designed in the same way, so that in the event of a respective force application during a crash a corresponding local deformation of the respective one or more chamber portions 10 is possible on both sides.

1. An energy storage device, comprising an energy storage with a housing and at least one storage module accommodated therein, as well as a frame to which the housing is fastened by means of screw elements screwed at distinct fastening positions, wherein the frame has at least two longitudinal beams which are formed by metal hollow profile elements,
wherein each hollow profile element has a main portion and at least one chamber portion which projects laterally from the housing and into which the screw elements are screwed, wherein the chamber portion is provided with one or more weakening devices to facilitate collapse of the chamber portion in the event that a force with a horizontal force component is applied.

2. The energy storage device according to claim 1, wherein two projecting chamber portions are preferably provided, which are spaced apart from one another when viewed transversely to the longitudinal direction of the longitudinal beam, and which are provided in particular at the upper and lower end of the longitudinal beam, wherein both chamber portions are provided with one or more weakening devices.

3. The energy storage device according to claim 1, wherein the chamber portion delimited by a chamber wall preferably has a square, in particular a trapezoidal, cross-section, wherein the chamber wall has a lower and an upper wall as well as a front wall connecting the two.

4. The energy storage device according to claim 1, wherein the one or more weakening device is formed by an opening passing through a chamber wall defining the chamber portion.

5. The energy storage device according to claim 3, wherein one or more each opening only passes through one wall or multiple walls of the chamber portion.

6. The energy storage device according to claim 4, wherein the one or more opening is a bore or a slot.

7. The energy storage device according to claim 6, wherein each slot extends vertically to a longitudinal axis of the longitudinal beam.

8. The energy storage device according to claim 1, wherein each weakening device is formed by a depression deforming a chamber wall defining the chamber portion.

9. The energy storage device according to claim 3, wherein each depression is provided only in one wall or in multiple walls or extends over multiple walls.

10. The energy storage device according to claim 8, wherein each depression is an embossed bead.

11. The energy storage device according to claim 1, wherein each weakening device is formed by a material weakening which reduces the thickness of a chamber wall defining the chamber portion.

12. The energy storage device according to claim 3, wherein each material weakening is provided only in one wall or in multiple walls or extends over multiple walls.

13. The energy storage device according to claim 1, wherein multiple fastening positions are provided along the longitudinal beam, wherein at least one respective weakening device is provided between two fastening positions.

14. The energy storage device according to claim 13, wherein multiple weakening devices are provided at a constant distance from one another between two fastening positions.

15. A motor vehicle, comprising at least one energy storage device according to claim 1.

16. The energy storage device according to claim 2, wherein the chamber portion delimited by a chamber wall preferably has a square, in particular a trapezoidal, cross-section, wherein the chamber wall has a lower and an upper wall as well as a front wall connecting the two.

17. The energy storage device according to claim 2, wherein the one or more weakening device is formed by an opening passing through a chamber wall defining the chamber portion.

18. The energy storage device according to claim 3, wherein the one or more weakening device is formed by an opening passing through a chamber wall defining the chamber portion.

19. The energy storage device according to claim 4, wherein one or more each opening only passes through one wall or multiple walls of the chamber portion.

20. The energy storage device according to claim 5, wherein the one or more opening is a bore or a slot.
